(19) United States
(12) Patent Application Publication
(10) Pub. No.: US 2018/0054386 A1
(43) Pub. Date: Feb. 22, 2018

(54) TABLE LOOKUP METHOD FOR DETERMING SET MEMBERSHIP AND TABLE LOOKUP APPARATUS USING THE SAME

(71) Applicant: ELECTRONICS AND TELECOMMUNICATIONS RESEARCH INSTITUTE, Daejeon (KR)

(72) Inventors: Hyun Yong LEE, Gwangju (KR); Bhum Cheol LEE, Daejeon (KR); Kang Il CHOI, Daejeon (KR)

(21) Appl. No.: 15/671,875

(22) Filed: Aug. 8, 2017

(30) Foreign Application Priority Data
Aug. 16, 2016 (KR) 10-2016-0103799

(51) Int. Cl. H04L 12/743; H04L 12/771; H04L 12/755

(52) U.S. Cl. CPC H04L 45/7453; H04L 45/021; H04L 45/56

(57) ABSTRACT

Provided is a table lookup method for a set membership query and a table lookup apparatus using the same. The table lookup apparatus includes a storage configured to store a first table and a second table, which include information needed for responding to a set membership query, and a controller configured to, when a set membership query for an element occurs, search the first table and the second table and output set information corresponding to the element, wherein the first table includes information about at least one element stored in each entry thereof according to a partial hash key of the at least one element, and the second table stores the at least one element and set information corresponding to the at least one element.

### CROSS-REFERENCE TO RELATED APPLICATION

This application claims priority to and the benefit of Korean Patent Application No. 10-2016-0103799, filed on Aug. 16, 2016, the disclosure of which is incorporated herein by reference in its entirety.

### BACKGROUND

### 1. Field of the Invention

The present invention relates to a table lookup method for determining a set membership and a table lookup apparatus using the same.

### 2. Discussion of Related Art

A conventional technology for resolving a set membership query is largely divided into two types of methods.

The first type of method uses a filter which is a data structure for supporting a membership query of a single set. In the first type of method, one filter is generated for one set, and filters of all sets are checked to determine a set to which a certain element belongs. The filter generated for one set may include a Bloom filter, a cuckoo filter, or other filters having a function equal thereto.

In the first type of method, as the number of sets increases, the number of filters to be generated increases, which increases a processing time and in turn raises an error probability in determining set membership.

The second type of method manages set information of elements in the form of a table and resolves a set membership query through a table lookup. Each entry of the table may include set information, to which a particular element belongs, or address information (for example, a pointer), in which the set information is stored. The second type of method applies a hash function to all or a part of an element, which is a subject of a set membership query, and determines which entry of the table is to be scanned on the basis of a result of the application. In the second type of method, set information corresponding to the element is searched for among pieces of set information included in the determined entry, and the element is assigned a corresponding set.

In the second type of method, an entry of the table stores an element together with set information or address information to resolve a hash collision, and thus more space is required as the number of elements increases. Also, when a space for storing a table is larger than a storage space that provides high speed access, such as a central processing unit (CPU) cache, a part of the table may be stored in a storage space that provides low speed access, such as a main memory, and thus lookup performance may be degraded.

### SUMMARY OF THE INVENTION

The present invention is directed to provide a table lookup method for determining a set membership which has a low error probability and a rapid processing time regardless of the number of elements by overcoming a conventional technical limitation of error probability and processing time increasing with an increase of the number of elements when determining a set membership based on a table, and a table lookup apparatus using the same.

In addition, the present invention is directed to provide a table lookup method for determining a set membership which prevents a table storage space from being influenced by the number and size of elements by storing a part of a result of a hash function being applied to an element in each entry instead of storing the element, and a table lookup apparatus using the same.

The present invention is directed to provide a table lookup method for determining a set membership which allows an entire area of a table to be stored in a low capacity storage device that supports high speed access, such as a central processing unit (CPU) cache and enables rapid lookup by reducing a table storage space for resolving a set membership query, and a table lookup apparatus using the same.

The technical objectives of the present invention are not limited to the above disclosure, and other objectives may become apparent to those of ordinary skill in the art based on the following descriptions.

In accordance with one aspect of the present invention, there is provided a table lookup apparatus including a storage configured to store a first table and a second table which include information needed for responding to a set membership query and a controller configured to, when a set membership query for an element occurs, search the first table and the second table and output set information corresponding to the element, wherein the first table includes information about at least one element stored in each entry thereof according to a partial hash key of the at least one element, and the second table stores the at least one element and set information corresponding to the at least one element.

In accordance with one aspect of the present invention, there is provided a table lookup method including: storing a first table and a second table which include information needed for responding to a set membership query; and, when a set membership query for a first element occurs, searching the first table and the second table and outputting set information corresponding to the first element, wherein the first table includes information about at least one element stored in each entry thereof, and the second table stores the at least one element and set information corresponding to the at least one element.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a software structure of a table lookup apparatus according to the present invention.

FIG. 2 is a drawing illustrating an example of a CFHash table according to the present invention.

FIGS. 3A and 3B are flowcharts showing a method of adding information about an element to a CFHash table performed by a table lookup apparatus according to the present invention.

FIGS. 4A and 4B are flowcharts showing a method of changing information about an element in a CFHash table performed by a table lookup apparatus according to the present invention.

FIGS. 5A and 5B are flowcharts showing a method of deleting information about an element in a CFHash table performed by a table lookup apparatus according to the present invention.

FIGS. 6A and 6B are flowcharts showing a table lookup method performed by a table lookup apparatus according to the present invention.

FIG. 7 is a drawing illustrating an embodiment in which an L2 routing table is looked up using a table lookup method according to the present invention.

FIG. 8 is a drawing illustrating an embodiment in which an L3 routing table is looked up using a table lookup method according to the present invention.

FIG. 9 is a drawing illustrating another embodiment in which an L3 routing table is looked up using a table lookup method according to the present invention.

FIG. 10 is a drawing illustrating an embodiment in which packets are distributed by a network interface card (NIC) using a table lookup method according to the present invention.

FIG. 11 is a block diagram illustrating a configuration of a table lookup apparatus according to the present invention.

### DETAILED DESCRIPTION OF EXEMPLARY EMBODIMENTS

In the description of the embodiments, detailed descriptions of related known functions or constructions will be omitted herein to avoid obscuring the subject matter of the present invention.

It should be understood that the term “comprise,” “include,” “may comprise” and/or “may include,” when used in the specification, specifies the presence of a feature, an operation, and a component stated herein but does not limit the addition of one or more features, operations, and components. It should be further understood that the term “comprise,” “include,” or “have,” when used in the specification, specifies the presence of stated features, integers, steps, operations, elements, components, and groups thereof, but does not preclude the presence or addition of one or more other features, integers, steps, operations, elements, components, and/or groups thereof.

As used herein, the singular forms “a,” “an,” and “the” are intended to include the plural forms as well unless clearly indicated otherwise by context

Hereinafter, the present invention will be described with reference to the accompanying drawings.

Determining a set to which a certain element belongs among a number of sets is one of features required across various information technology (IT) fields. For example, a feature of determining a reception queue to which a packet received by a network interface card (NIC) is distributed, an interface to which a packet received by a router/switch is transmitted, and a physical machine in which a virtual machine requested by a cloud computing environment is executed correspond to a feature of determining a set to which a given element belongs.

The present invention relates to determining a set to which a certain element belongs among a number of sets to which the certain element may possibly belong, and relates to a table lookup method for determining a set membership, and a table lookup apparatus using the same.

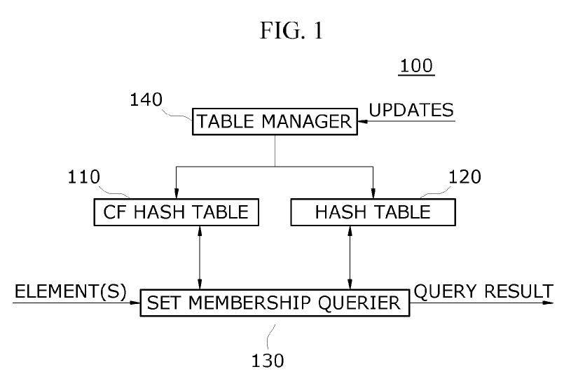

FIG. 1 is a block diagram illustrating a software structure of a table lookup apparatus according to the present invention.

Referring to FIG. 1, a table lookup apparatus 100 according to the present invention includes a CFHash table 110, a hash table 120, a set membership querier 130, and a table manager 140.

The CFHash table 110 may store information required to perform a table lookup for resolving a set membership query. Each entry of the CFHash table 110 may include all or a part of a result of a hash function being applied to an element and set information of an element corresponding to a partial hash key as information about at least one element.

Each of the entries of the CFHash table 110 may also include a collision flag, which is an indicator informing of the impossibility of resolving a set membership query due to a hash collision, as the information about at least one element. The collision flag may be set to a specific value, e.g. 1, when different elements have the same hash function application result (either all or part of the result). Since the CFHash table 110 includes all or a part of a hash function application result as identification information of an element, when different elements have the same hash function application result, it is unable to identify the element using the hash function application result in the CFHash table 110. Accordingly, when different elements have the same hash function application result, a collision flag corresponding to the hash function application result is set to a specific value to indicate a result of whether a collision occurred.

The CFHash table 110 may include a plurality of entries, and each of the entries may include the above described information.

The hash table 120 may store information required to perform the table lookup for resolving a set membership query. Each entry of the hash table 120 includes an element and set information corresponding to the element (hereinafter, referred to as element-set information). Alternatively, each entry of the hash table 120 includes the element and storage information of the set information corresponding to the element (e.g. a pointer for an address of a storage location).

According to embodiments of the present invention, the set information and the storage information (address information) constituting each of the entries of the hash table 120 may be stored to resolve a hash collision with regard to the CFHash table 110. In other words, when different elements have the same hash function application result and thus set information of an element is unable to be identified using the CFHash table 110, the table lookup apparatus 100 identifies the element by using the hash table 120 and determines the set information. To this end, the hash table 120 may store information for resolving a hash collision based on separate chaining or open addressing.

The hash table 120 may include a plurality of entries, and each of the entries may include the above identified information.

The CFHash table 110 may be generated to include information about an element which is constituted based on the element-set information before a table lookup for resolving a set membership query is performed. The information about an element may include the element, a result of a hash function being applied to the element, and set information corresponding to the element. The hash table 120 may be generated based on the element-set information before the table lookup for resolving a set membership query is performed.

Once the CFHash table 110 and the hash table 120 are initially generated, the information about an element may be added, changed, or deleted.

The set membership querier 130 performs a set membership query on one or more elements on the basis of the CFHash table 110 and the hash table 120, and returns a result of the set membership query.

The set membership querier 130 may perform a primary set membership query on the CFHash table 110. In response to not succeeding in determining a set membership query through the primary set membership query with respect to the CFHash table 110, the set membership querier 130 may perform a secondary set membership query on the hash table 120. According to an embodiment, the set membership querier 130 may end the set membership query in response to not succeeding in determining a set membership through the primary set membership query of the CFHash table 110.

The table manager 140 may be configured to, when element-set information is added/changed/deleted, apply the added/changed/deleted element-set information to the CFHash table 110 and the hash table 120.

Hereinafter, operations of the above-described elements of the table lookup apparatus 100 will be described in detail.

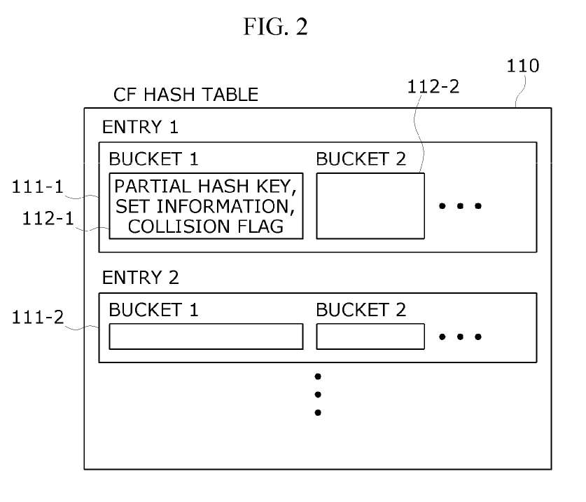

FIG. 2 is a drawing illustrating an example of a CFHash table according to the present invention.

Referring to FIG. 2, the CFHash table 110 according to the present invention includes at least one of entries 111-1 and 111-2.

Each of the entries 111-1 and 111-2 include at least one of buckets 112-1 and 112-2. Each of the buckets 112-1 and 112-2 may store information about a corresponding element. The information about an element includes a partial hash key of the element, set information of the element, and a collision flag.

The partial hash key may include a part of a result of a hash function being applied to the element. That is, the partial hash key may be a result obtained by applying a hash function, which is configured to output a predetermined length of resultant bits, to an element.

For example, the partial hash key may correspond to least significant bits of a result of a hash function being applied to an element. For example, the partial hash key may correspond to most significant bits of a result of a hash function being applied to an element. According to embodiments of the present invention, the CFHash table 110 may store a result of a bit-wise operation (for example, OR, XOR, or AND) being applied to each predetermined length of the result of the hash function being applied to the element, instead of storing the partial hash key.

In FIG. 2, each of the entries 111-1 and 111-2 of the CFHash table 110 is described as including a partial hash key, but according to embodiments, each of the entries 111-1 and 111-2 of the CFHash table 110 may include all of the hash key, and all of the hash key may include all of the result of the hash function being applied to the element.

The set information of an element may include information about a set to which an element having a corresponding partial hash value belongs as a member. According to an embodiment, the set information may include an address of a location at which information about a set, to which an element having a corresponding partial hash value belongs as a member, is stored.

A collision flag may include information indicating whether one or more different elements have the same partial hash key.

One of the buckets 112-1 and 112-2 may store one partial hash key, and may store set information corresponding to the stored partial hash key and a collision flag. A plurality of elements may have the same hash key, and when the plurality of elements have the same set information, the set information is constituted as the corresponding set information and the collision flag is set to a default. Meanwhile, when the plurality of elements each have different pieces of set information, the collision flag is set to a specific value, e.g. 1.

According to embodiments of the present invention, the information about an element may be stored in one of the entries 111-1 and 111-2 in the CFHash table 110 according to a preset rule.

For example, the information about an element may be stored in the entry 111-1 or 111-2 corresponding to a value of an operation “hash (element) % table size” performed on the result of a hash function being applied to the element. For example, the information about an element may be stored in the entry 111-1 or 111-2 corresponding to a result of the element being processed by cuckoo hashing or d-left hashing. The information about an element may be stored in the bucket 112-1 or 112-2 in the determined entry 111-1 or 111-2.

When new element-set information is added, corresponding element-set information may be added as information about an element to a bucket at the front or rear of the determined entry 111-1 or 111-2 or at a certain location of the entry 111-1 or 111-2 determined according to the above-described rule.

In the embodiment of the present invention, each of the entries 111-1 and 111-2 of the CFHash table 110 may be composed including only a limited number of buckets 112-1 and 112-2. In case of new element-set information being added, when the limited number of buckets 112-1 and 112-2 exist in the determined entry 111-1 or 111-2 (i.e. there is no empty bucket), the table lookup apparatus may delete existing information about an element and add the new element-set information to the determined entry 111-1 or 111-2 as the information about the element according to various replacement policy. In the embodiment, the existing information about an element to be deleted may be selected on the basis of a Line-replaceable unit (LRU).

According to another embodiment of the present invention, each of the entries 111-1 and 111-2 of the CFHash table 110 may be configured to support an unlimited number of the buckets 112-1 and 112-2.

According to embodiments of the present invention, after the CFHash table 110 is initially generated, the table lookup apparatus may add/change/delete information about an element to correspond to an addition/change/deletion of element-set information. Hereinafter, a method of adding/changing/deleting information about an element of the CFHash table 110 will be described in detail.

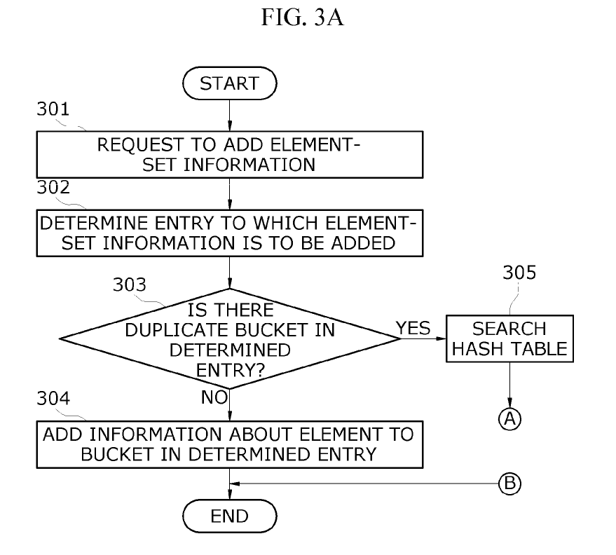

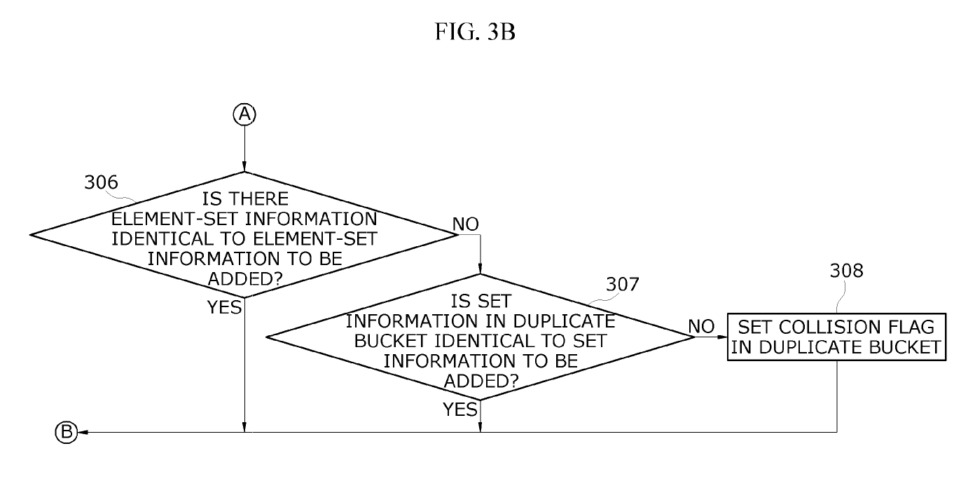

FIGS. 3A and 3B are flowcharts showing a method of adding information about an element to a CFHash table performed by a table lookup apparatus according to the present invention.

Referring to FIGS. 3A and 3B, the table lookup apparatus according to the present invention may be configured to, when a request for adding element-set information occurs (301), determine an entry to which information about an element is added to a CFHash table in response to element-set information (302). The request for adding element-set information may include element-set information to be added.

The entry to which the element-set information is to be added may be determined to correspond to a value of an operation “hash(element)% table size” performed on a result of a hash function being applied to a corresponding element.

Then, the table lookup apparatus determines whether there is a bucket having the same partial hash value as the element, that is, duplicate buckets, in the determined entry (303).

When there are no duplicate buckets in the determined entry, the table lookup apparatus constructs information about the element on the basis of the element-set information to be added, and then stores the information about the element in a bucket of the determined entry (304). The table lookup apparatus constructs the information about the element by using a partial hash value generated by a hash function being applied to the element, set information, and a collision flag (which is not set to a specific value). The table lookup apparatus may additionally store the information about the element at a location at the front or rear of the entry or at a certain location determined according to a preset rule.

According to an embodiment, when the CFHash table supports only a limited number of buckets, the table lookup apparatus may determine whether the limited number of buckets already exist in the determined entry. When the limited number of buckets already exist in the entry, the table lookup apparatus may delete specific element-set information in the determined entry according to a preset rule, and may then store the constructed information about the element.

Meanwhile, when a duplicate bucket exists in the determined entry, the table lookup apparatus searches the hash table (305) and determines whether element-set information which is the same as the element-set information to be added exists in the hash table (306).

The existence of the same element-set information as the element-set information to be added to the hash table indicates that the corresponding information about the element already exists in the CFHash table. Accordingly, the table lookup apparatus ends an adding operation.

When element-set information which is the same as the element-set information to be added does not exist in the hash table, the table lookup apparatus determines whether set information included in the duplicate bucket is the same as the set information to be added (307).

When the set information included in the duplicate bucket is the same as the set information to be added, the table lookup apparatus ends the operation without adding the element-set information. The table lookup apparatus may additionally add the element-set information to be added to the hash table, independent of the CFHash table.

Meanwhile, when the set information included in the duplicate bucket is not the same as the set information to be added, the table lookup apparatus sets a collision flag included in the duplicate bucket (308) and ends the operation. For example, the table lookup apparatus may set a collision flag value included in the duplicate bucket to 1. The table lookup apparatus may additionally store the element-set information to be added to the hash table, independent of the CFHash table.

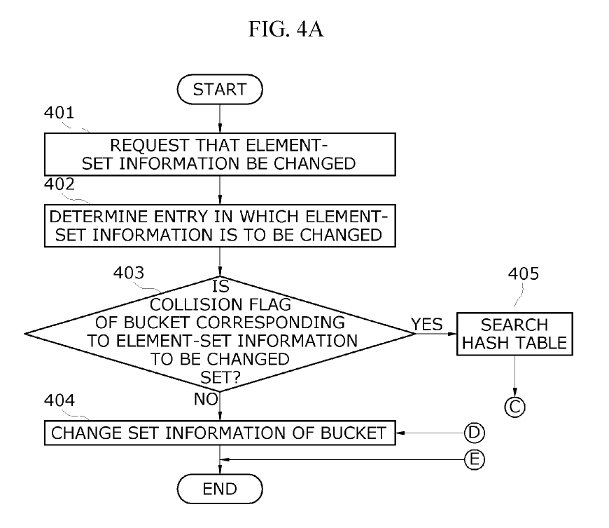

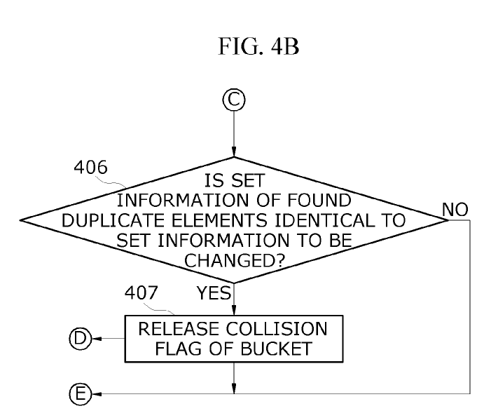

FIGS. 4A and 4B are flowcharts showing a method of changing information about an element in a CFHash table performed by a table lookup apparatus according to the present invention.

Referring to FIGS. 4A and 4B, the table lookup apparatus according to the present invention may be configured to, when a request for changing element-set information occurs (401), determine an entry in which information about an element to be changed is stored in a CFHash table (402). The request for changing element-set information may include element-set information to be changed.

The entry in which the information about the element to be changed is stored may be determined in the same manner that the element-set information is added. For example, the entry in which the information about the element to be changed is stored may be determined to correspond to a value of an operation “hash(element)% table size” performed on a result of a hash function being applied to the element to be changed, as described with reference to FIG. 2.

Then, the table lookup apparatus determines whether a collision flag of a bucket corresponding to the element-set information to be changed is set in the determined entry (403). In detail, the table lookup apparatus may determine whether a collision flag of the bucket is set to a specific value, e.g. 1.

When the collision flag is not set, the table lookup apparatus changes set information of the bucket corresponding to the request for changing the element-set information (404). The table lookup apparatus may change the corresponding element-set information in a hash table, independent of the CFHash table.

When the collision flag is set, the table lookup apparatus searches the hash table (405) to find elements having the same partial hash key as the element to be changed, that is, duplicate elements.

When the found duplicate elements have the same set information as the set information to be changed (406), the table lookup apparatus releases the collision flag of the bucket corresponding to the element-set information to be changed (407) and changes the set information (404). The table lookup apparatus may change the corresponding element-set information in the hash table, independent of the CFHash table.

Meanwhile, when the found duplicate elements have set information different from the set information to be changed (406), the table lookup apparatus does not change the element-set information of the CFHash table and ends a changing operation. The table lookup apparatus may change the corresponding element-set information in the hash table, independent of the CFHash table.

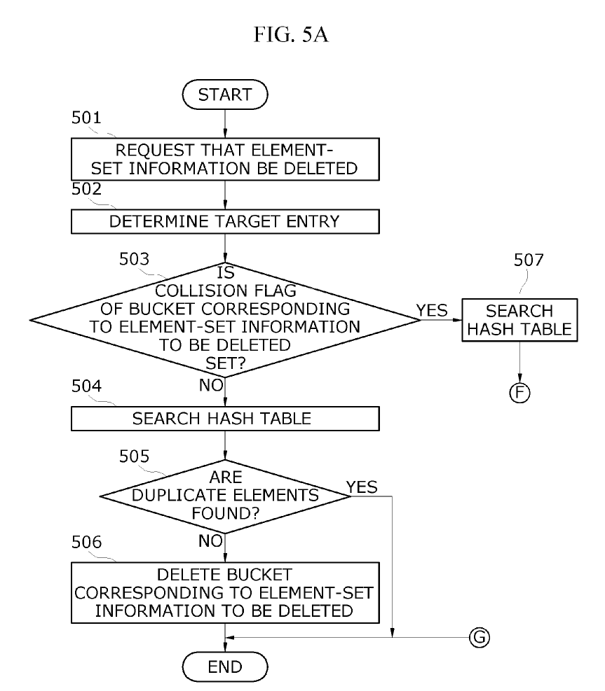

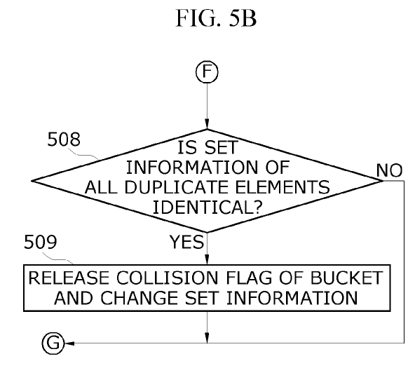

FIGS. 5A and 5B are flowcharts showing a method of deleting information about an element in a CFHash table performed by a table lookup apparatus according to the present invention.

Referring to FIGS. 5A and 5B, the table lookup apparatus according to the present invention may be configured to, when a request for deleting element-set information occurs (501), determine an entry in which information about an element to be deleted is stored in a CFHash table (502). The request for deleting element-set information may include element-set information to be deleted.

The entry in which the information about the element to be deleted is stored may be determined in the same manner that the element-set information is added. For example, the entry in which the element-set information to be deleted is stored may be determined to correspond to a value of an operation “hash(element)% table size” performed on a result of a hash function being applied to the element to be deleted, as described with reference to FIG. 2.

Then, the table lookup apparatus determines whether a collision flag of a bucket corresponding to the element-set information to be deleted is set in the determined entry (503). In detail, the table lookup apparatus may determine whether a collision flag of the bucket is set to a specific value, e.g. 1.

When the collision flag is not set, the table lookup apparatus searches a hash table (504) to find elements having the same partial hash key as the element to be deleted, that is, duplicate elements.

When the duplicate elements are not found (505), the table lookup apparatus deletes the bucket corresponding to the request for deleting element-set information (or information about an element stored in the bucket) (506). The table lookup apparatus may delete the corresponding element-set information in the hash table.

When the duplicate elements are found (505), the table lookup apparatus ends a deleting operation without deleting the element-set information of the CFHash table. The table lookup apparatus may delete the corresponding element-set information in the hash table, independent of the CFHash table.

Meanwhile, when the collision flag of the bucket including the element-set information to be deleted is set (503), the table lookup apparatus searches the hash table (507) to find duplicate elements.

When all of the found duplicate elements have the same set information (508), the table lookup apparatus releases the collision flag of the bucket, and changes the set information to the set information of the found duplicate elements (509). When all of the found duplicate elements do not have the same set information (508), the table lookup apparatus maintains the collision flag of the bucket that is set and ends the deleting operation without deleting the element-set information. The table lookup apparatus may delete the corresponding element-set information in the hash table, independent of the CFHash table.

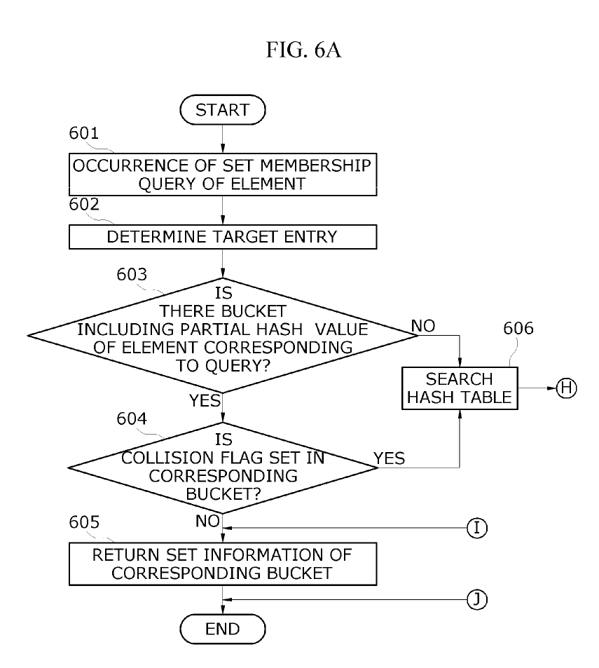

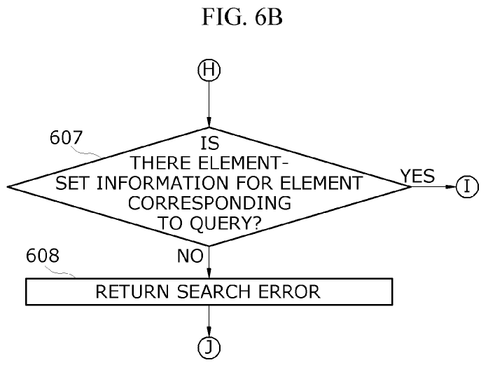

FIGS. 6A and 6B are flowcharts showing a table lookup method performed by a table lookup apparatus according to the present invention.

Referring to FIGS. 6A and 6B, a table lookup apparatus according to the present invention may be configured to, when a set membership query of an element occurs (601), determine an entry in which information about an element corresponding to the query is stored in a CFHash table (602). The set membership query of the element may include information pointing to an element for which a set is desired to be determined.

The entry in which the information about the element corresponding to the query is stored may be determined to correspond to a value of an operation “hash(element)% table size” performed on a result of a hash function being applied to the element for which a set is to be determined, as described with reference to FIG. 2.

Then, the table lookup apparatus determines whether there is a bucket including a partial hash value of the element corresponding to the query in the determined entry (603).

When the bucket including the partial hash value of the element corresponding to the query exists in the determined entry, the table lookup apparatus determines whether a collision flag is set in the corresponding bucket (604).

When the collision flag is not set in the corresponding bucket, the table lookup apparatus returns set information included in the corresponding bucket in response to the query (605) and ends the search.

When the collision flag is set in the corresponding bucket, the table lookup apparatus may return a search error for a primary set membership query. Then, the table lookup apparatus may additionally perform a secondary set membership query by using a hash table or end the search.

Hereinafter, the secondary set membership query performed by the table lookup apparatus using the hash table will be described.

The table lookup apparatus searches the hash table (606) and determines whether element-set information for an element corresponding to the query exists in the hash table (607).

When the element-set information for the element corresponding to the query exists in the hash table, the table lookup apparatus returns the found set information (605) and ends the search.

When the element-set information for the element corresponding to the query does not exist in the hash table, the table lookup apparatus returns a search error (608) and ends the search.

According to embodiments of the present invention, various methods may be used to increase a speed of finding set information of an element corresponding to a query.

For example, buckets of each entry may store values of an OR bitwise operation applied to a partial hash value such that the values are used to search for a bucket corresponding to an element.

Hereinafter, various embodiments adopting the above described table lookup method according to the present invention will be described.

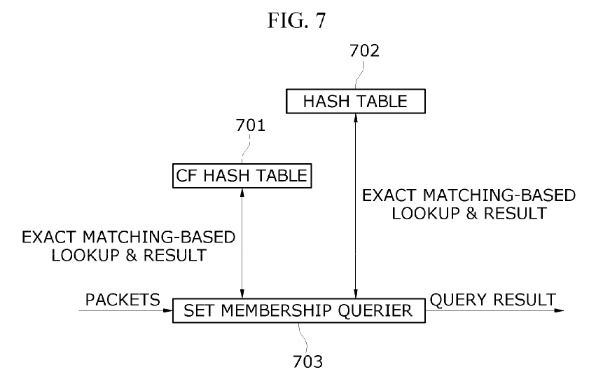

FIG. 7 is a drawing illustrating an embodiment in which an L2 routing table is looked up using a table lookup method according to the present invention.

In the embodiment shown in FIG. 7, a CFHash table 701 supports an exact matching-based routing table lookup. In the embodiment shown in FIG. 7, an element is a destination media access control (MAC) address of a packet, and set information is an interface to which the packet needs to be transmitted.

A size of a partial hash value of the CFHash table 701 may be adjusted in consideration of the number of interfaces of a router, a size of a routing table, and a storage space of a location at which the CFHash table 701 is stored such that the partial hash value of the CFHash table 701 is stored in a desired storage space.

The CFHash table 701 and a hash table 702 may be generated before being used to lookup the L2 routing table on the basis of entries of a given L2 routing table. In addition, the CFHash table 701 and the hash table 702 may dynamically add/change/delete element-set information in order to reflect entries of the L2 routing table that are dynamically added/changed/deleted.

A set membership querier 703 performs a primary lookup on the CFHash table 701 for a given packet based on the above-described method. When required interface information is not obtained from the CFHash table 701, the set membership querier 703 may perform a secondary lookup on the hash table 702 to obtain the interface information.

The given packet may be transmitted to a corresponding interface based on the interface information obtained via the table lookup.

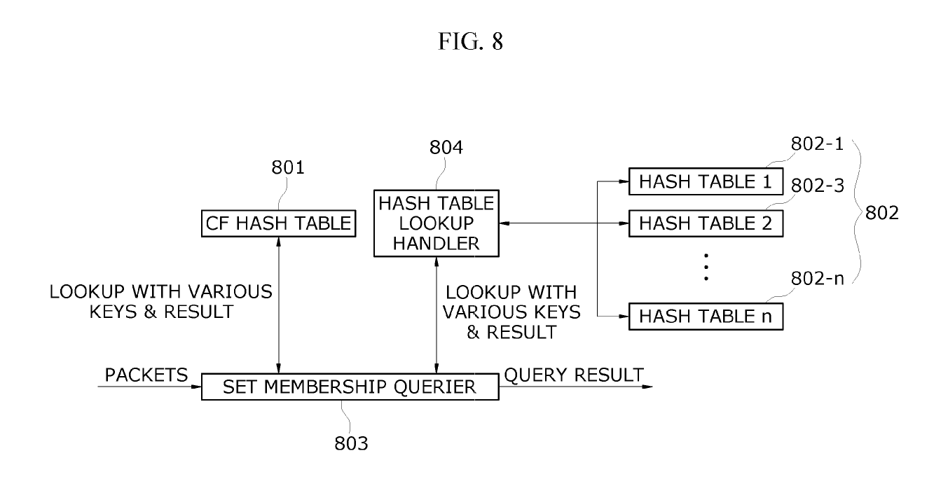

FIG. 8 is a drawing illustrating an embodiment in which an L3 routing table is looked up using a table lookup method according to the present invention.

In the embodiment shown in FIG. 8, a CFHash table 801 supports a routing table lookup. In the embodiment shown in FIG. 8, an element is a destination IP address provided with various prefix lengths.

A size of a partial hash value of the CFHash table 801 may be adjusted in consideration of the number of interfaces of a router, a size of a routing table, and a storage space of a location at which the CFHash table 801 is stored such that the partial hash value of the CFHash table 801 is stored in a desired storage space.

The CFHash table 801 and a hash table 802 may be generated before being used to lookup the L3 routing table on the basis of entries of a given L3 routing table. The CFHash table 801 may store a destination IP address provided with various prefix lengths and set information corresponding thereto. For example, the CFHash table 801 may include a destination IP address provided with various prefixes, such as A.B.C/24, D.E/16, F.G.H.I/25, as an element.

The L3 routing table may be represented by one or more hash tables 802-1, 802-2, and 802-n. For example, entries of the L3 routing table may be divided into subdivided L3 routing tables based on a length of the prefix, and each of the subdivided L3 routing tables may form one of the hash tables 802-1, 802-2, and 802-n. In this case, each of the hash tables 802-1, 802-2, and 802-n may store a destination IP address having a prefix length corresponding to the each hash table 802-1, 802-2, and 802-n and an interface corresponding to the each destination IP address. For example, the first hash table 802-1 stores destination IP addresses, which each have a prefix of/24, and interfaces corresponding to the destination IP addresses, and a second hash table 802-2 stores destination IP addresses, which each have a prefix of/22, and interfaces corresponding to the destination IP addresses. In this case, the set information of the CFHash table 801 may include an index of a hash table in which a corresponding element is stored.

The CFHash table 801 and the hash table 802 may dynamically add/change/delete element-set information in order to reflect entries of the L3 routing table that are dynamically added/changed/deleted.

A set membership querier 803 performs a primary lookup on the CFHash table 801 for a given packet based on the above-described method. For the primary lookup, the CFHash table 801 may use one or more elements. For example, for a destination address A.B.C.D, that is, an object of a query, when the CFHash table 801 stores prefix lengths of/16, /24, and /25, the CFHash table 801 may use elements of A.B/16, A.B.C/24, and A.B.C.D/25 for the lookup.

When the set membership querier 803 obtains index information of a subdivided hash table in which a destination IP address corresponding to the query is stored via the lookup of the CFHash table 801, the set membership querier 803 may instruct that a hash table lookup handler 804 search the corresponding subdivided hash table. When the set membership querier 803 does not obtain set information via the search of the corresponding subdivided hash table, the set membership querier 803 may allow the hash table lookup handler 804 to search the remaining subdivided hash tables.

Meanwhile, when the set membership querier 803 does not obtain index information of a subdivided hash table in which a destination IP address corresponding to the query is stored via the lookup of the CFHash table 801, the set membership querier 803 may instruct that the hash table lookup handler 804 search all of the hash tables 802-1, 802-2, and 802-n.

The given packet may be transmitted to a corresponding interface based on interface information obtained via the table lookup.

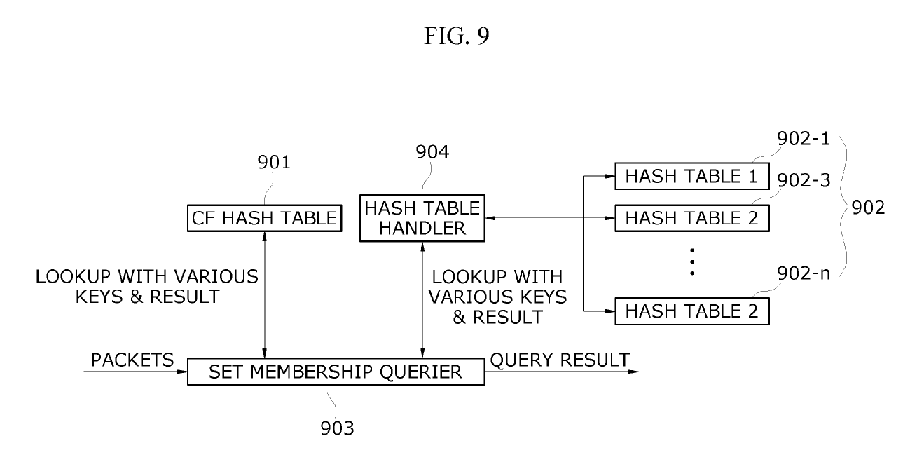

FIG. 9 is a drawing illustrating another embodiment in which an L3 routing table is looked up using a table lookup method according to the present invention.

FIG. 9 illustrates an example of a routing table lookup supporting L3 longest prefix matching using a CFHash table 901. In the embodiment shown in FIG. 9, an element may be a destination IP address provided with various prefix lengths.

A size of a partial hash value of the CFHash table 901 may be adjusted in consideration of the number of interfaces of a router, a size of a routing table, and a storage space of a location at which the CFHash table 901 is stored such that the partial hash value of the CFHash table 901 is stored in a desired storage space.

The CFHash table 901 and a hash table 902 may be generated before being used to lookup the L3 routing table on the basis of entries of a given L3 routing table.

The CFHash table 901 may store a destination IP addresses provided with various prefix lengths and set information corresponding thereto. For example, the CFHash table 901 may include a destination IP address provided with various prefixes, such as A.B.C/24, D.E/16, and F.G.H.I/25, as an element.

The L3 routing table may be represented by one or more hash table 902-1, 902-2, and 902-n as described in the embodiment of FIG. 8.

Set information of an element stored in the CFHash table 901 and the hash table 902 may be interface information to which a corresponding element is to be transmitted.

In addition, the CFHash table 901 and the 902 may dynamically add/change/delete element-set information in order to reflect entries of the L3 routing table that are dynamically added/changed/deleted.

A set membership querier 903 performs a primary lookup on the CFHash table 901 for a given packet based on the above-described method. For the primary lookup, the CFHash table 901 may use one or more elements. For example, for a destination IP address A.B.C.D, that is, an object of the query, when the CFHash table 901 stores prefix lengths of/16, /24, and /25, the CFHash table 801 may use elements of A.B/16, A.B.C/24, and A.B.C.D/25 for the lookup.

When the set membership querier 903 obtains index information of a subdivided hash table in which a destination IP address corresponding to the query is stored via the lookup of the CFHash table 901, the set membership querier 903 may instruct that a hash table lookup handler 904 search the corresponding subdivided hash table. When the set membership querier 903 does not obtain set information via the search of the corresponding subdivided hash table, the set membership querier 903 may allow the hash table lookup handler 904 to search the remaining subdivided hash tables.

Meanwhile, when the set membership querier 903 does not obtain index information of a subdivided hash table in which a destination IP address corresponding to the query is stored via the lookup of the CFHash table 901, the set membership querier 903 may instruct that the hash table lookup handler 904 search all of the hash tables 902-1, 902-2, and 902-n.

The given packet may be transmitted to a corresponding interface based on interface information obtained via the table lookup.

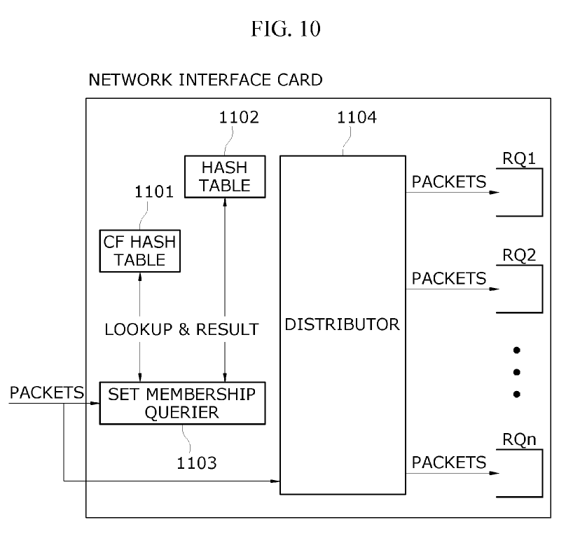

FIG. 10 is a drawing illustrating an embodiment in which packets are distributed by a NIC using a table lookup method according to the present invention.

For packet processing performance, packets belonging to the same flow (packets sharing the same destination/receiving end IP address/port number and protocol type) need to be distributed to the same core through the same reception queue.

In the embodiment shown in FIG. 10, an element is a flow ID (destination/receiving end IP address/port number and protocol type; destination/receiving end IP address/port number; or any other arbitrary information capable of distinguishing a flow), and set information is a reception queue ID.

A size of a partial hash value of a CFHash table 1001 may be adjusted in consideration of the number of reception queues, the number of flow table entries, and a memory space of the NIC such that the partial hash value of the CFHash table 1001 is stored in the NIC.

A set membership querier 1003 performs a primary lookup on the CFHash table 1001 for a given packet based on the above-described method. When required reception queue information is not obtained from the CFHash table 1001, the set membership querier 1003 may perform a secondary lookup on a hash table 1002 to obtain the reception queue information.

The obtained reception queue information is provided to a distributor 1004, which serves to transmit packets to a reception queue in the NIC, so that the corresponding packet is distributed to a desired reception queue.

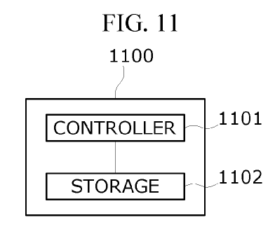

FIG. 11 is a block diagram illustrating a configuration of a table lookup apparatus according to the present invention.

Referring to FIG. 11, a table lookup apparatus 1100 according to the present invention includes a controller 1101 and a storage 1102.

The controller 1101 controls each component of the table lookup apparatus 1100 to perform the table lookup methods according to the present invention which have been described above with reference to FIGS. 1 to 10. As described above, the controller 1101 may construct a CFHash table and a hash table to support a set membership query, and perform an adding/changing/deleting operation. In addition, the controller 1101 may search for set information corresponding to an element by using the CFHash table and the hash table, and provide a search result.

In the above described embodiments, the controller 1101 may perform an operation corresponding to a set membership querier.

Detailed operations of the controller 1101 are as follows.

The storage 1102 may store a CFHash table and a hash table according to the present invention.

In addition, the table lookup apparatus 1100 according to the present invention may be provided with a communicator or an output, such as a display, to output set information as a result of a set membership search.

As should apparent from the above, the table lookup method for determining set membership according to the present invention and the table lookup apparatus using the same can enhance efficiency in storing a table by storing all or a part of a result of a hash function being applied to an element in a table.

In addition, the table lookup method for determining set membership according to the present invention and the table lookup apparatus using the same can speed up lookup performance since an entire area of a table can be stored in a low capacity storage space that supports high speed access, such as a CPU cache, while increasing storage efficiency.

In addition, the table lookup method for determining set membership according to the present invention and the table lookup apparatus using the same can provide the same lookup performance regardless of the number of candidates for a set to which an element may belong.

In the description above, although all of the components of the embodiments of the present invention may have been explained as assembled or operatively connected as a unit, the present invention is not intended to be limited to such embodiments. Rather, within the objective scope of the present invention, any number of the components may be selectively and operatively combined. Also, every one of the components may be implemented singly in hardware, while each of the components can also be selectively combined in part or as a whole and implemented in a computer program having program modules for executing functions of hardware equivalents thereof. The computer program may be stored in computer readable media, which can realize the embodiments of the present invention when executed. Candidates of the computer readable media include magnetic recording media, optical recording media, and carrier wave media.

Those skilled in the art should appreciate that various modifications, changes, and substitutions to the embodiments are possible without departing from the scope and spirit of the invention. The embodiments disclosed in the specification and drawings are illustrated to aid in the explanation and understanding of the present invention and are not intended to limit the scope spirit of the present invention. As such, it should be understood that other equivalents and modifications could be made thereto without departing from the spirit and scope of the invention.

What is claimed is:

1. A table lookup apparatus comprising:
a storage configured to store a first table and a second table, which include information needed for responding to a set membership query; and
a controller configured to, when a set membership query for a first element occurs, search the first table and the second table and output set information corresponding to the first element,
wherein the first table includes information about at least one element stored in each entry thereof, and
the second table stores the at least one element and set information corresponding to the at least one element.

2. The table lookup apparatus of claim 1, wherein the information about the at least one element includes a partial hash key, which is a part of a result of a hash function being applied to the at least one element, set information of an element corresponding to the partial hash key or storage information of the set information, and a collision flag for the partial hash key,
wherein when a plurality of the elements have the same partial hash key, a collision flag for the same partial hash key is set to a specific value.

3. The table lookup apparatus of claim 2, wherein the information about the at least one element is stored in one of buckets included in an entry corresponding to a result of a preset operation being performed on a partial hash key of the at least one element.

4. The table lookup apparatus of claim 3, wherein the controller is configured to, when the set membership query for the first element occurs, determine an entry corresponding to a partial hash value of the first element in the first table, search the determined entry for a bucket in which the partial hash value of the first element is stored, and, when a collision flag included in a found bucket is not set to the specific value, output set information included in the found bucket.

5. The table lookup apparatus of claim 4, wherein the controller is configured to, when a bucket in which the partial hash value of the first element is stored is not found in the determined entry or when the collision flag included in the found bucket is set to the specific value, search the second table to output set information corresponding to the first element.

6. The table lookup apparatus of claim 5, wherein the controller is configured to output a search error when the set information corresponding to the first element is not found in the second table.

7. The table lookup apparatus of claim 3, wherein the controller is configured to, when a request for adding a second element or set information corresponding to the second element occurs, determine an entry corresponding to a partial hash value of the second element in the first table, search the determined entry for a bucket in which the partial hash value of the second element is stored, and, when a bucket in which the partial hash value of the second element is stored is not found, store information about the second element in one of buckets included in the determined entry.

8. The table lookup apparatus of claim 7, wherein the controller is configured to, when a bucket in which the partial hash value of the second element is stored is found, search the second table for set information corresponding to the second element, and, when the set information corresponding to the second element is not identical to the set information found in the second table, set a collision flag of the found bucket to the specific value.

9. The table lookup apparatus of claim 3, wherein the controller is configured to, when a request for changing set information corresponding to a third element occurs, determine an entry corresponding to a partial hash value of the third element in the first table, search the determined entry for a bucket in which the partial hash value of the third element is stored, and, when a collision flag included in a found bucket is not set to the specific value, change set information included in the found bucket to the set information corresponding to the third element.

10. The table lookup apparatus of claim 9, wherein the controller is configured to, when the collision flag included in the found bucket is set to the specific value, search the second table for pieces of set information of elements having the same partial hash value as the third element, and, when found pieces of set information are identical to each other, set the collision flag included in the found bucket to a default value and change the set information included in the found bucket to the set information corresponding to the third element.

11. The table lookup apparatus of claim 3, wherein the controller is configured to, when a deletion of set information corresponding to a fourth element occurs, determine an entry corresponding to a partial hash value of the fourth element in the first table, search the determined entry for a bucket in which the partial hash value of second element is stored, and, when a collision flag included in a found bucket is not set to the specific value and only one element is found to have the same partial hash value as the fourth element in the second table, delete information about an element in the found bucket.

12. The table lookup apparatus of claim 11, wherein the controller is configured to, when a bucket in which the partial hash value of the second element is stored is not found in the determined entry and pieces of set information corresponding to elements having the same partial hash value as the fourth element are identical to each other in the second table, set a collision flag included in the searched bucket to a default value, and change set information included in the searched bucket to the set information corresponding to the elements having the same partial hash value as of the fourth element.

13. A table lookup method comprising:
storing a first table and a second table, which include information needed for responding to a set membership query; and
when a set membership query for a first element occurs, searching the first table and the second table and outputting set information corresponding to the first element,
wherein the first table includes information about at least one element stored in each entry thereof, and
the second table stores the at least one element and set information corresponding to the at least one element.

14. The table lookup method of claim 13, wherein the information about the at least one element includes a partial hash key, which is a part of a result of a hash function being applied to the at least one element, set information of an element corresponding to the partial hash key or storage information of the set information, and a collision flag for the partial hash key,
wherein when a plurality of the elements have the same partial hash key, a collision flag for the same partial hash key is set to a specific value.

15. The table lookup method of claim 14, wherein the information about the at least one element is stored in one of buckets included in an entry corresponding to a result of a preset operation being performed on the partial hash key of the at least one element.

16. The table lookup method of claim 15, wherein, when the set membership query with respect to the first element occurs, the outputting of set information corresponding to the first element comprises:
determining an entry corresponding to a partial hash value of the first element in the first table;
searching the determined entry for a bucket in which the partial hash value of the first element is stored;
when a bucket in which the partial hash value of the first element is stored is found in the determined entry, determining whether a collision flag included in the bucket is set to the specific value;
when the collision flag included in the found bucket is not set to the specific value, outputting set information included in the found bucket;
when a bucket in which the partial hash value of the first element is stored is not found in the determined entry or when the collision flag included in the found bucket is set to the specific value, searching the second table to output set information corresponding to the first element; and
when the set information corresponding to the first element is not found in the second table, outputting a search error.

17. The table lookup method of claim 15, further comprising, when a request for adding a second element or set information corresponding to the second element occurs:
determining an entry corresponding to a partial hash value of the second element in the first table
searching the determined entry for a bucket in which the partial hash value of the second element is stored;
when a bucket in which the partial hash value of the second element is stored is not found, storing information about the second element in one of buckets included in the determined entry; and
when a bucket in which the partial hash value of the second element is stored is found, searching the second table for set information corresponding to the second element, and, when the set information corresponding to the second element is not identical to the set information found in the second table, setting a collision flag of the found bucket to the specific value.

18. The table lookup method of claim 15, further comprising, when a request for changing set information corresponding to a third second element occurs:
determining an entry corresponding to a partial hash value of the third element in the first table;
searching the determined entry for a bucket in which the partial hash value of the third element is stored;
when a collision flag included in a found bucket is not set to the specific value, changing set information included in the found bucket to the set information corresponding to the third element; and
when the collision flag included in the found bucket is set to the specific value, searching the second table for pieces of set information of elements having the same partial hash value as the third element, and, when the found pieces of set information are identical to each other, setting the collision flag included in the found bucket to a default value and changing the set information included in the found bucket to the set information corresponding to the third element.

19. The table lookup method of claim 15, further comprising, when a deletion of set information corresponding to a fourth element occurs:
determining an entry corresponding to a partial hash value of the fourth element in the first table;
searching the determined entry for a bucket in which the partial hash value of second element is stored;
when a bucket in which the partial hash value of the second element is stored is found in the determined entry, determining whether a collision flag included in the found bucket is set to the specific value;
when the collision flag included in the found bucket is not set to the specific value and only one element is found to have the same partial hash value as the fourth element in the second table, deleting information about an element in the found bucket; and
when a bucket in which the partial hash value of the second element is stored is not found in the determined entry and pieces of set information corresponding to elements having the same partial hash value as the fourth element are identical to each other in the second table, setting a collision flag included in the searched bucket to a default value, and changing set information included in the searched bucket to the set information corresponding to the elements having the same partial hash value as the fourth element.
